(19) United States
(12) Patent Application Publication
(10) Pub. No.: US 2025/0346155 A1
(43) Pub. Date: Nov. 13, 2025

(54) PREFABRICATED MOUNTING ASSEMBLY

(71) Applicants: Hyundai Motor Company, Seoul (KR); Kia Corporation, Seoul (KR); Shin Young Co., Ltd., Yeongcheon-si (KR)

(72) Inventors: Seong-Su Shin, Hwaseong-si (KR); Jeong-Pil Choi, Suwon-si (KR)

(21) Appl. No.: 18/940,369

(22) Filed: Nov. 7, 2024

(30) Foreign Application Priority Data
May 10, 2024 (KR) 10-2024-0061615

(51) Int. Cl. B60N 2/015

(52) U.S. Cl. CPC B60N 2/015

(57) ABSTRACT

An embodiment prefabricated mounting assembly includes a mounting bracket, the mounting bracket including a top surface having a first fastening hole, a pair of side parts extending downward from opposite ends of the top surface, and a plurality of ribs disposed between the side parts, and a reinforcement component disposed between the top surface of the mounting bracket and a rib of the plurality of ribs and including a first fastener engaged in a second fastening hole disposed in a main body of the reinforcement component.

### CROSS-REFERENCE TO RELATED APPLICATIONS

This application claims the benefit of Korean Patent Application No. 10-2024-0061615, filed on May 10, 2024, which application is hereby incorporated herein by reference in its entirety.

### TECHNICAL FIELD

The present disclosure relates to a prefabricated mounting assembly.

### BACKGROUND

Embodiments of the present disclosure relate to a prefabricated mounting assembly for mounting a vehicle seat, for example, a mounting member mounted on a support to engage and support an assembly object.

As an example, a seat S of a vehicle is mounted on a seat crossmember C mounted on a panel P using a seat mounting bracket 10, as illustrated in FIG. 1.

Referring to FIG. 2, the seat mounting bracket 10 for mounting the seat is often made of an extruded aluminum material to increase structural rigidity and reduce weight. Although the extruded aluminum material has an internal rib structure 11 to provide excellent structural rigidity, the extruded material makes it difficult to apply a high-strength nut 20 or bolt hardware to the interior due to its nature of the closed end section. For example, in order to apply a clinching nut into the aluminum extrusion, a gap for an assembly device to load the nut and fasten the same to a base material is required, and the more complex the internal rib shape of the extruded material, the more difficult it is to insert the assembly device into the extruded material.

Therefore, a passing hole 12 is often required in an opposite surface of an assembly surface so that a feeder F may pass therethrough as illustrated in FIG. 3. However, this requires additional machining to remove the internal rib and the opposite surface of the extruded material, which has the major disadvantages of a reduction in the rigidity of the part and an increase in machining costs.

In addition, the seat mounting body structure needs to be highly stiffened to ensure seat belt anchorage strength. The arrow in FIG. 1 shows a loading direction in a seat belt anchor test.

In the seat belt anchor test, it is required by law that a high load (typically 20 times the weight of the seat) is applied to the front of a vehicle and there is no failure under this test. Therefore, it is highly efficient to apply an extruded aluminum material with optimized internal rib geometry to the seat mounting bracket 10, which protrudes from the seat crossmember C that is a main member. Paradoxically, the tighter the internal ribs 11, the stiffer and stronger the bracket, but the less favorable the conditions for applying the hardware (e.g., nut 20) to the mounting surface. If the nut 20 is applied in addition to adding the machined passing hole 12 mentioned above, the ribs may be deleted, resulting in a decrease in stiffness and strength.

On the other hand, referring to FIG. 4, in order to secure the mounting strength of a seat mounting bracket 31, a reinforcement component 32 with separate hardware applied mainly to the inside of the mounting surface may be welded to the seat mounting bracket as a leaf plate. Although this reinforcement component 32 is easy to be loaded when applied to an open end section, it is very difficult to be loaded due to its shape of turning at 90 degrees with respect to the mounting surface when applied to an extruded material with a closed end section as illustrated in FIGS. 2 and 3. In this case, the mounting surface needs to be flipped down and a separate positioning jig, a hole, etc. need to be set up, complicating the assembly process, and depending on the shape of the internal ribs of the extruded material, it may be impossible to assemble the reinforcement component 32.

Furthermore, the mounting hardware (e.g., the nut 20) applied to the inside of the extruded material directly or via the welded reinforcement component 32 suffers from the inefficiency of having to replace the entire extruded material if the hardware is damaged during the seat mounting process (e.g., due to thread failure during fastening).

As illustrated in FIG. 1, the seat mounting bracket 10 is mechanically bonded to the seat crossmember C, which is the main skeleton member, by MIG welding and FDS bonding, so that if the entire seat mounting extruded material needs to be replaced, there is a major problem in that the entire body skeleton member suffers from damage.

Furthermore, as illustrated schematically in FIG. 5, depending on the layout characteristics of a vehicle, the greater the amount of protrusion of the seat mounting bracket 10 (height of the seat mounting bracket), the greater the accumulated body assembly tolerance and shape tolerance of the seat mounting bracket 10, so separate precise jig equipment is required to reduce the tolerances, and the cost of securing the quality for assembling the seat to the vehicle body is increased.

The foregoing background description is intended to provide an understanding of the background of embodiments of the disclosure and may include matters that are not the already known prior art.

### SUMMARY

Embodiments of the present disclosure provide a prefabricated mounting assembly having a structure that facilitates assembly of a reinforcement component with a nut applied to the inside of a mounting bracket made of an extruded aluminum material.

An embodiment of the present disclosure provides a prefabricated mounting assembly including a mounting bracket having a top surface with a fastening hole and side parts extending downward from both horizontally lateral ends of the top surface with a plurality of ribs formed between the side parts and a reinforcement component inserted between the top surface of the mounting bracket and a rib of the plurality of ribs, with a fastener engaged in a fastening hole formed in a main body thereof.

The plurality of ribs may include a pair of uppermost protruded ribs each spaced apart from an undersurface of the top surface and protruding inwardly from the side parts, and the reinforcement component may be inserted between the top surface of the mounting bracket and the uppermost protruded ribs.

The reinforcement component may be detachable from the mounting bracket.

The reinforcement component may be movably inserted into the mounting bracket.

At least one of the plurality of ribs may separate an internal space of the mounting bracket into upper and lower spaces therefrom.

The mounting bracket may be provided with inwardly recessed stopper notches at both longitudinally lateral ends.

The reinforcement component may be inserted into the mounting bracket through the longitudinally lateral end thereof, and the reinforcement component may be provided, on a front end in the insertion direction, with an anti-disengagement protrusion protruding upwardly.

The anti-disengagement protrusion may protrude upwardly in a curved manner as to be elastically deformed and seated into the stopper notch.

The reinforcement component may have longitudinal position-restricting protrusions protruding outwardly from the side parts relative to the insertion direction, and a gap may be formed between the longitudinal position-restricting protrusions of the reinforcement component inserted into the mounting bracket and an inner surface of the mounting bracket.

The reinforcement component may have vertical position-restricting burring flanges protruding downwardly at front and rear ends of a side portion relative to the insertion direction, and a gap may be formed between the vertical position-restricting burring flanges of the reinforcement component fitted into the mounting bracket and the uppermost protruded ribs.

The reinforcement component may have an anti-disengagement step protruding upwardly at the rear end relative to the insertion direction and stopped by the stopper notch, and a gap may be formed between the anti-disengagement protrusion and the stopper notch and between the anti-disengagement step and the stopper notch.

The mounting bracket and the reinforcement component may be engaged with each other by another fastener fastening the fastener.

The reinforcement component may be inserted into the mounting bracket through the longitudinally lateral end thereof, the reinforcement component may be provided, on front and rear ends, respectively, in the insertion direction, with an anti-disengagement protrusion protruding upwardly and an anti-disengagement step protruding downwardly and stopped by the protruded ribs, and a gap may be formed between the anti-disengagement protrusion and the stopper notch and between the anti-disengagement step and the stopper notch.

According to the prefabricated mounting assembly of embodiments of the present disclosure, the nut-applied reinforcement component may be easily assembled into or replaced from the mounting bracket made of extruded aluminum material, and during the assembly or replacement, a separate drilling process or the like is not required to remove a joint.

In addition, a tolerance of 2 mm in the X/Y/Z direction is secured to allow for the absorption of deviation in mounting positions between the assembly object and the vehicle body occurring due to the assembly error.

Thus, despite the ease of assembly, the rigidity of the mounting member may be maintained without compromising rib stiffness.

Furthermore, no passing hole machining is required, which is advantageous in terms of weight and price.

### BRIEF DESCRIPTION OF THE DRAWINGS

FIG. 1 illustrates a vehicle seat mounted on a panel;

FIGS. 2 and 3 illustrate a conventional seat mounting structure;

FIG. 4 illustrates another conventional seat mounting structure;

FIG. 5 illustrates assembly tolerances in the conventional seat mounting structure;

FIGS. 6 and 7 illustrate configurations of a prefabricated mounting assembly according to an embodiment of the present disclosure;

FIG. 8 illustrates a side view of a reinforcement component of FIG. 7;

FIG. 9 illustrates an assembled state of the prefabricated mounting assembly according to an embodiment of the present disclosure;

FIG. 10 illustrates the degrees of freedom and range of a flowable motion in the assembled state as illustrated in FIG. 9;

FIG. 11 illustrates a portion of a lateral side of the assembled prefabricated mounting assembly as illustrated in FIG. 9;

FIG. 12 illustrates a portion of a top side of the assembled prefabricated mounting assembly as illustrated in FIG. 9;

FIGS. 13 to 18 sequentially illustrate the assembly and replacement process of a prefabricated mounting assembly according to an embodiment of the present disclosure; and

FIGS. 19 and 20 illustrate a prefabricated mounting assembly according to another embodiment of the present disclosure.

### DETAILED DESCRIPTION OF ILLUSTRATIVE EMBODIMENTS

The foregoing objectives, features, and advantages will be further described in detail with reference to the accompanying drawings, so that one of ordinary skill in the art to which the present disclosure belongs will readily practice the technical ideas of the present disclosure.

In describing embodiments of the present disclosure, when it is determined that a detailed description of the known art related to the present disclosure would unnecessarily obscure the gist of the disclosure, the detailed description will be shortened or omitted.

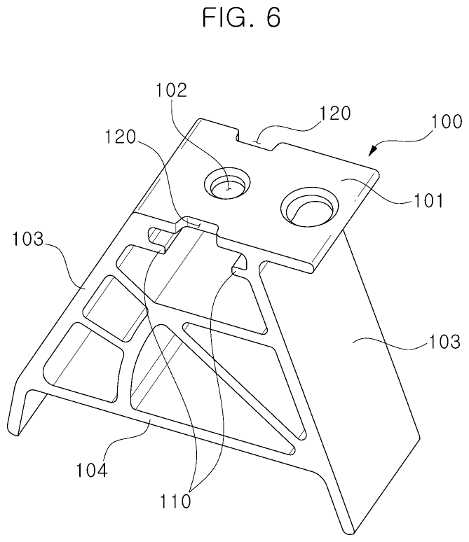

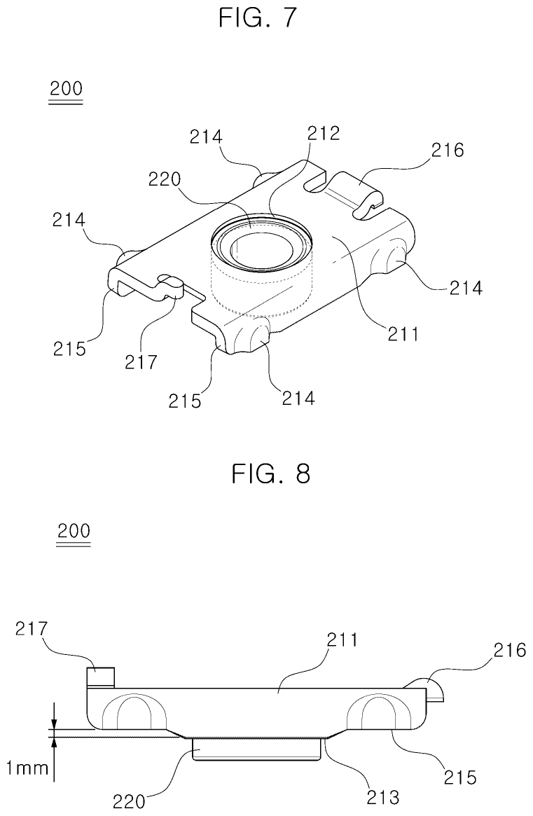

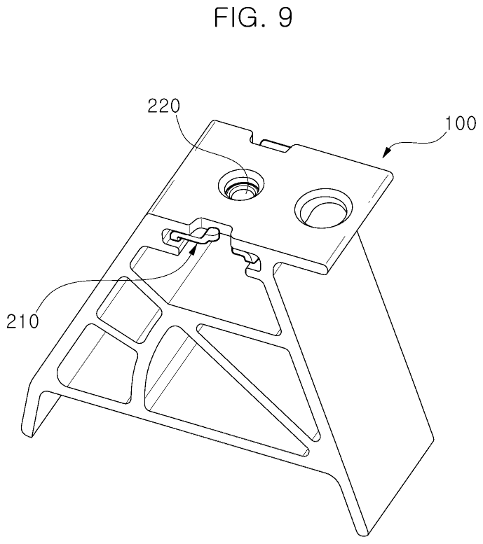

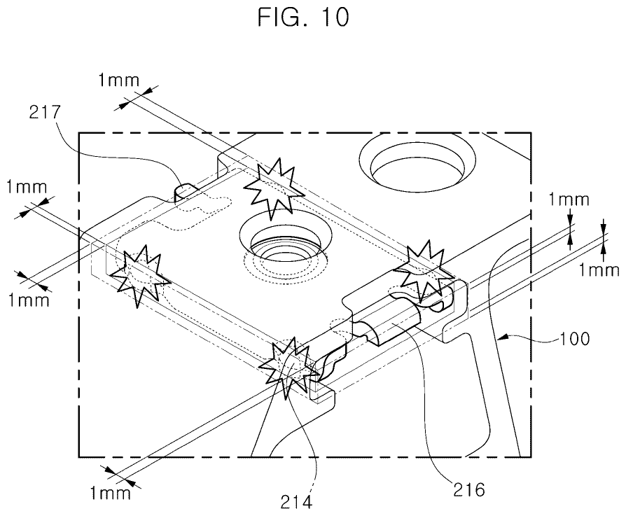

FIGS. 6 and 7 illustrate configurations of a prefabricated mounting assembly according to an embodiment of the present disclosure, FIG. 8 illustrates a side view of a floating reinforcement component of FIG. 7, and FIG. 9 illustrates an assembled state of the prefabricated mounting assembly according to an embodiment of the present disclosure.

Hereinafter, the prefabricated mounting assembly according to an embodiment of the present disclosure will be described with reference to FIGS. 6 to 9.

The prefabricated mounting assembly of embodiments of the present disclosure may be applied to a mounting structure that requires high strength hardware inside an extruded material and may be a mounting assembly for mounting a vehicle seat, for example. For example, a mounting assembly for mounting a seat is mounted on a seat crossmember C or the like of a vehicle such that an upper portion engages the seat S so that the seat S is mounted on a vehicle body in a spaced manner therefrom.

The prefabricated mounting assembly includes a mounting bracket 100 and a reinforcement component 200.

The reinforcement component 200 of embodiments of the present invention is combined with the mounting bracket 100, and a gap is formed so that the reinforcement component 200 can float. Considering this characteristic, it can be called a floating reinforcement component.

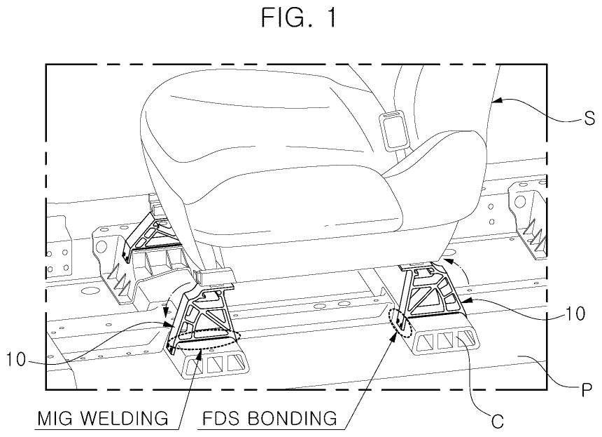

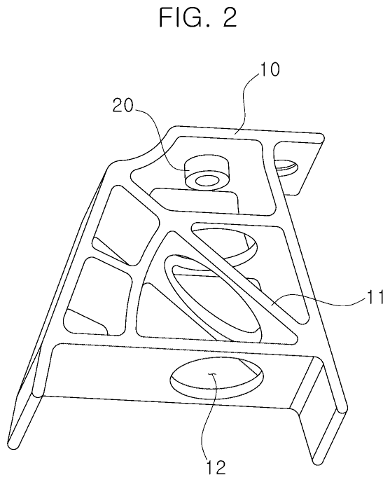

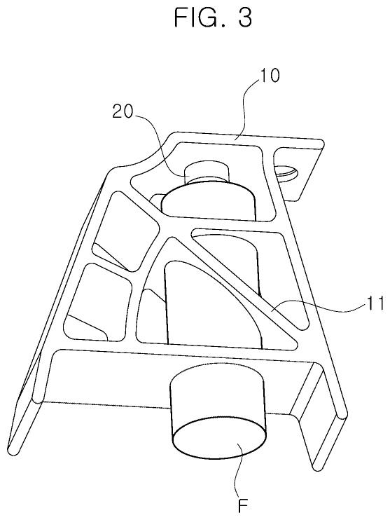

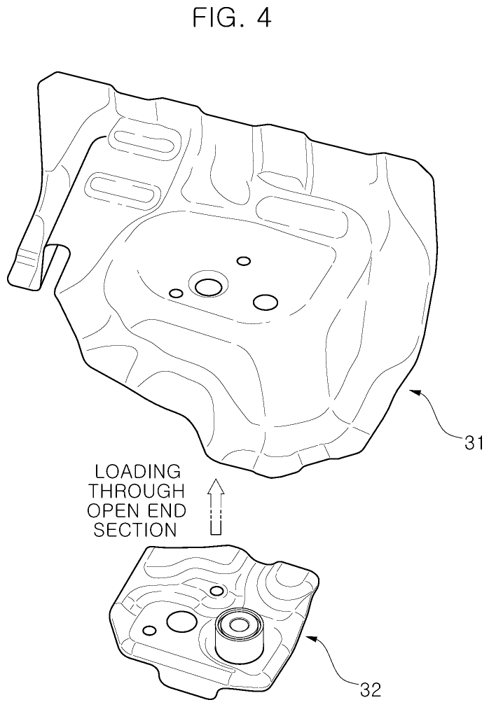

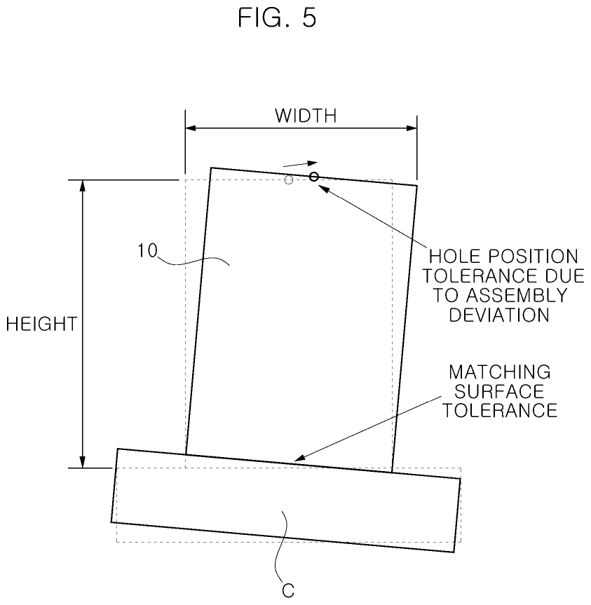

The mounting bracket 100 may be an extruded material, such as Al, and may have a top surface 101 with a fastening hole 102 formed therein to engage a lower side of a seat S (see FIG. 1) and horizontally lateral side parts 103 extending downwardly from both horizontally lateral ends of the top surface 101. As illustrated, the two side parts 103 may be inclined to separate away from each other in a downward direction to engage the seat crossmember C (see FIG. 1) or the like.

Furthermore, the mounting bracket 100 may have various shapes of ribs 104 formed between the two side parts 103 and between the ribs 104 to ensure rigidity of the seat mounting bracket 100.

Further, at least one of the ribs is connected between the two side parts 103 such that the mounting bracket 100 is configured in a closed end section, separating an internal space of the mounting bracket 100 into upper and lower spaces. In other words, the mounting bracket 100 of embodiments of the present disclosure does not require a passing hole connecting to the fastening hole 102 from the bottom as in a conventional manner.

On the other hand, the ribs 104 have a pair of uppermost protruded ribs 110 protruding in a spaced manner from an undersurface of the top surface 101.

Thus, the protruded ribs 110 each protrude inwardly from the two side parts 103 and are spaced apart from each other, so that the floating reinforcement component 200 to be described later may be inserted through a space between the top surface 101 and the protruded ribs 110 as illustrated in FIG. 9.

Furthermore, at two longitudinally lateral ends other than the two horizontally lateral ends from which the side parts 103 extend, the top surface 101 is provided with inwardly recessed stopper notches 120 to facilitate engagement and disengagement with respect to the floating reinforcement component 200 to be described later.

Next, the floating reinforcement component 200 includes a reinforcement element 210, which is inserted and coupled to the space between the top surface 101 and the protruded ribs 110 of the mounting bracket 100, and a fastener, such as a nut 220, which is coupled to the reinforcement element 210. The nut 220 may be a clinching nut, a riveting nut, or a welding nut.

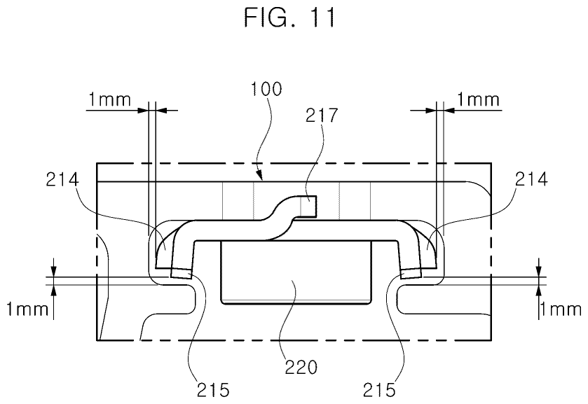

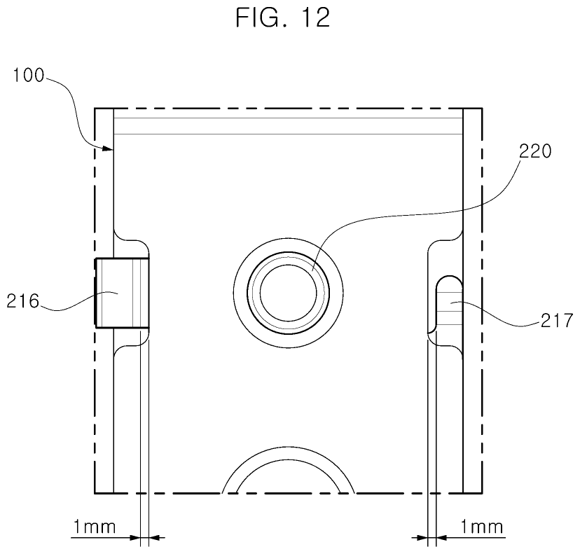

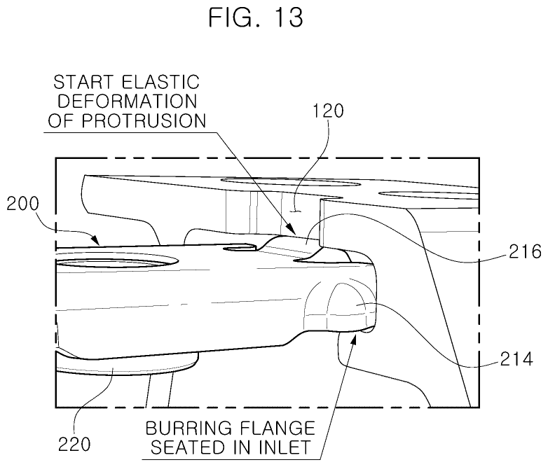

Referring to FIGS. 10 to 12, the reinforcement element 210 has a fastening hole 212 formed in a main body 211 and main burring flanges 213 formed around the fastening hole 212.

Accordingly, the nut 220 is mounted in the fastening hole 212 inwardly of the main burring flanges 213 to correspond to the fastening hole 102 of the mounting bracket 100.

The reinforcement element 210 is provided, at front and rear ends, respectively, in the insertion direction of the reinforcement component 200 into the mounting bracket 100, with an anti-disengagement protrusion 216 and an anti-disengagement step 217.

Furthermore, the reinforcement element 210 has longitudinal position-restricting protrusions 214 on both side parts.

The floating reinforcement component 200 is inserted inside the mounting bracket 100 and is assembled and position-restricted by an interference fit between parts without separate mechanical coupling such as welding or riveting.

The longitudinal position-restricting protrusions 214 are formed to protrude outwardly from each of the two side parts.

Further, the reinforcement element 210 is provided, on front and rear sides, with vertical position-restricting burring flanges 215 to restrict the vertical position of the reinforcement element 210 during assembly.

The anti-disengagement protrusion 216 is formed on the front end of the main body 211 to flexibly protrude upwardly so that the protrusion is configured to be elastically deformed upon insertion and restored in the stopper notch 120 after insertion.

In addition, the anti-disengagement step 217 is formed at the rear end of the main body 211 to protrude upwardly so that the step is configured to prevent the reinforcement element 210 from being disengaged by catching in the stopper notch 120 after insertion.

Such a reinforcement element 210 may be press-formed.

As such, the floating reinforcement component 200 is inserted inside the mounting bracket 100 so that its position is restricted by the interference fit between the parts without separate mechanical coupling such as welding or riveting.

Accordingly, the position in the longitudinal direction (X) is regulated within a flowable gap of 2 mm between the longitudinal position-restricting protrusions 214 and an inner shape of the mounting bracket 100, the position in the vertical direction (Z) is regulated within a flowable gap of 2 mm between the vertical position-restricting burring flanges 215 and an inner shape of the extruded material, and the position in the insertion direction (Y) is regulated within a flowable gap of 2 mm between the anti-disengagement protrusion 216/the anti-disengagement step 217 and the stopper notch 120 in the extruded material. As a result, the floating reinforcement component 200 is inserted into the extruded material and does not dislodge, but it is “suspended” with a 2 mm flowable gap in the X/Y/Z directions.

Therefore, when another fastener, such as a bolt, engages with the fastener upon mounting of a seat, the floating reinforcement component 200 is automatically positioned and regulated by rotational flow in the X/Y/Z axes.

Due to this structural feature, the structure is easily assembled without any assembly error between parts when bolts are engaged.

Hereinafter, the assembly and replacement process of the prefabricated mounting assembly of embodiments of the present disclosure will be described with reference to FIGS. 13 to 18.

The mounting bracket 100, which is made by aluminum extrusion, has protruded ribs (rails) 110 for insertion of the floating reinforcement component 200. The insertion direction of the floating reinforcement component 200 is the same as the extrusion direction of the extruded material, and the structure serves as a guide rail during assembly of the floating reinforcement component 200.

Therefore, as illustrated in FIG. 13, the insertion of the floating reinforcement component 200 is started by aligning the floating reinforcement component 200 with the protruded ribs 110 of the mounting bracket 100.

Once inserted into the rails, position-restriction in the insertion direction is regulated by the anti-disengagement protrusion 216 and the anti-disengagement step 217 of the floating reinforcement component 200. Furthermore, the position-restriction in the longitudinal direction is regulated by the longitudinal position-restricting protrusions 214, which have a 2 mm gap with the extruded material and thus serve to partially regulate the deflection in the insertion direction. When the floating reinforcement component 200 starts to be inserted, the anti-disengagement protrusion 216 is elastically deformed by about 1 mm in the downward direction because the vertical position-restricting burring flanges 215 are seated in the protruded ribs 110.

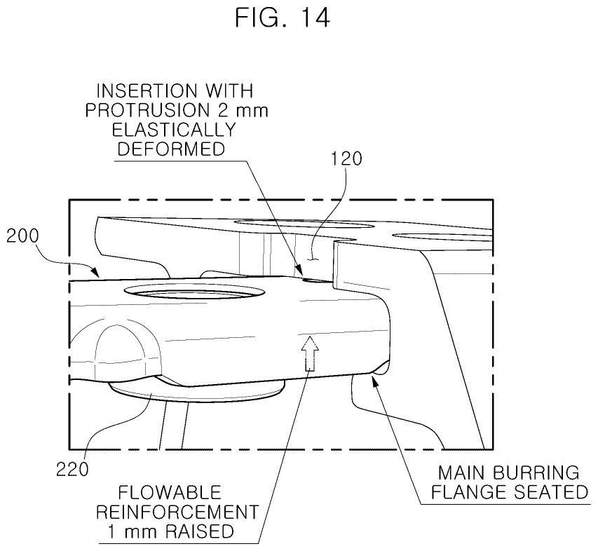

Thus, while the floating reinforcement component 200 is inserted along the rail with frictional force, the anti-disengagement protrusion 216 is inserted with 2 mm elastically deformed and the main burring flanges 213 are seated as illustrated in FIG. 14.

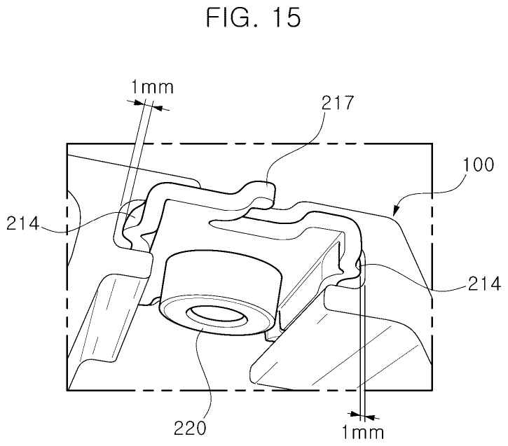

Then, as illustrated in FIG. 15, the reinforcement component 200 moves along the protruded ribs 110 with a 2 mm gap in the longitudinal direction (X) due to the longitudinal position-restricting protrusions 214.

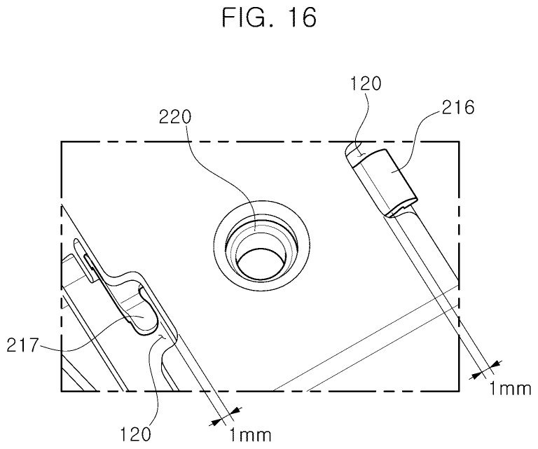

At the point of insertion completion of the reinforcement component 200 after insertion along the rail, the anti-disengagement protrusion 216 reaches the machined surface of the stopper notch 120 of the extruded material and is elastically restored, as illustrated in FIG. 16. The frictional force caused by the surface compression that occurred during the rail insertion process is eliminated, and the elastically restored shape of the anti-disengagement protrusion 216, along with the anti-disengagement step 217, which are seated in the stopper notch 120, regulate the y-directional position of the floating reinforcement component 200.

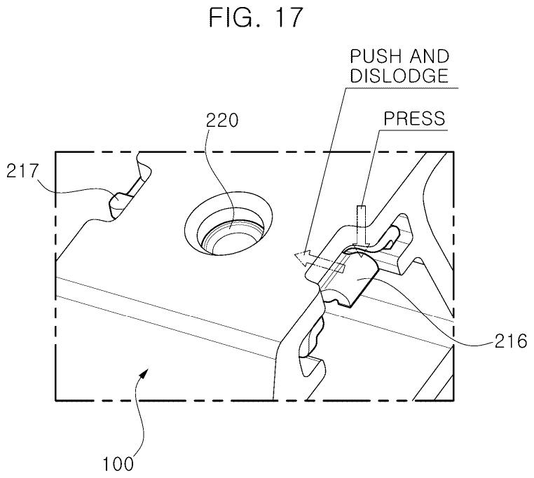

Replacement of the floating reinforcement component 200 inserted in this manner pushes the floating reinforcement component 200 in the Y direction by depressing the anti-disengagement protrusion 216, as illustrated in FIG. 17.

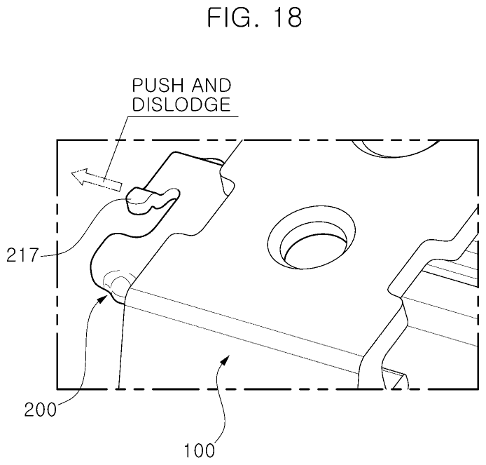

The floating reinforcement component 200 may then be removed by pulling the anti-disengagement step 217, as illustrated in FIG. 18.

The prefabricated mounting assembly of embodiments of the present disclosure has an assembly structure that is easy to remove and replace as described above. In other words, in the event of hardware damage, the floating reinforcement component 200 may be easily removed and replaced with a new part without damaging the extruded material and drilling to remove a separate joint.

In addition, securing the 2 mm flowable gap in the X/Y/Z directions enables absorption of mounting tolerance between the assembly object and the vehicle body caused by assembly error.

Furthermore, when it is necessary to apply high-strength hardware inside a complex-shaped closed end section extruded material, it is possible to apply a high-strength hardware of a thick reinforcement panel without deleting internal ribs of the extruded material, and no passing hole is required, thereby reducing costs and eliminating concerns about rigidity/strength degradation due to machining of the passing hole.

Preferably, the prefabricated mounting assembly of embodiments of the present disclosure described above has stopper notches 120 formed in the mounting bracket, so that the floating reinforcement component 200 has the anti-disengagement protrusion 216 and the anti-disengagement step 217, which are seated in the stopper notches 120.

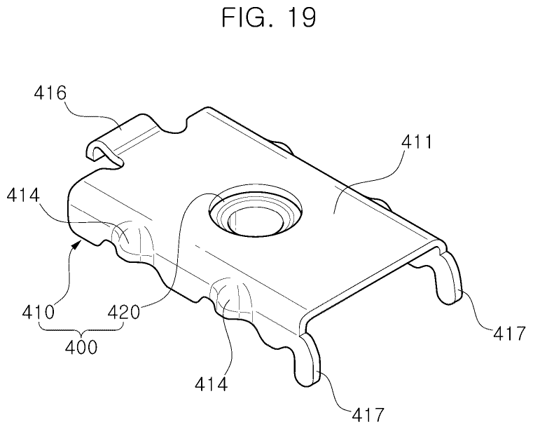

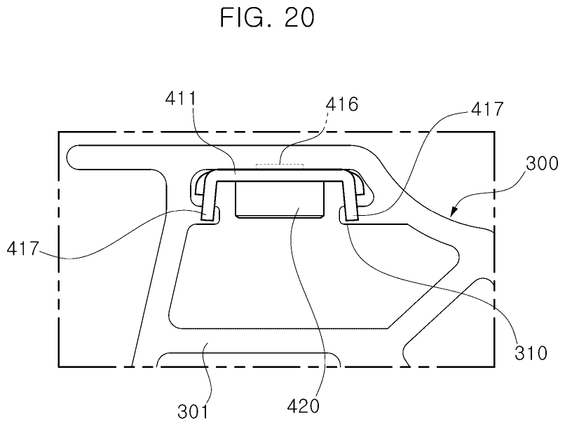

However, embodiments of the present disclosure are also adaptable to a mounting bracket in which the stopper notches 120 are not formed, and such a modified embodiment is illustrated in FIGS. 19 and 20.

In describing the modified embodiment, the same configuration as the previous embodiment will be omitted.

A prefabricated mounting assembly according to the modified embodiment includes a seat mounting bracket 300 and a floating reinforcement component 400.

The mounting bracket 300 has ribs 301 formed thereon, with the uppermost ribs of the ribs 301 formed as protruded ribs 310 spaced apart from an undersurface of a top surface of the mounting bracket.

The protruded ribs 310 are formed in a pair to protrude inwardly from side parts in a spaced manner from each other and function as rails into which the floating reinforcement component 400 is inserted.

On the other hand, unlike the previous embodiment, two horizontally lateral ends of the top surface are not provided with inwardly recessed stopper notches.

The floating reinforcement component 400 includes a reinforcement element 410 and a fastener, such as a nut 420, fastened to the reinforcement element 410.

The reinforcement element 410 has a fastening hole formed in a main body 411 and a main burring flange formed around the fastening hole.

The reinforcement element 410 is provided, on front and rear ends, respectively, of the main body 411 relative to the insertion direction of the reinforcement component 400 into the seat mounting bracket 300, with an anti-disengagement protrusion 416 and an anti-disengagement step 417.

Furthermore, the reinforcement element 410 may be provided on both horizontally lateral surfaces with longitudinal position-restricting protrusions 414, and the reinforcement element 410 may also have a vertical position-restricting burring flange.

Furthermore, since the anti-disengagement step 417 may not be seated in the stopper notch as in the previous embodiment, the anti-disengagement step 417 is formed to protrude downwardly from the rear end of the longitudinally lateral portion, and after being inserted, the anti-disengagement step 417 is caught in the protruded ribs 310 to restrict the position in the longitudinal direction.

The mounting assembly of embodiments of the present disclosure described above is also applicable to a detachable mounting body structure, such as a high-voltage battery mounting, a sub-frame mounting, and the like, where high strength hardware is required within an extruded material.

While the foregoing disclosure has been described with reference to the illustrative drawings, it will be apparent to those of ordinary skill in the art that it is not limited to the embodiments described, and that various modifications and variations may be made without departing from the spirit and scope of the present disclosure. Accordingly, such modifications or variations should be considered as falling within the scope of the claims of the present disclosure, and the scope of the present disclosure should be construed based on the appended claims.

What is claimed is:

1. A prefabricated mounting assembly comprising:
a mounting bracket comprising:
a top surface comprising a first fastening hole;
a pair of side parts extending downward from opposite ends of the top surface; and
a plurality of ribs disposed between the side parts; and
a reinforcement component disposed between the top surface of the mounting bracket and a rib of the plurality of ribs and comprising a first fastener engaged in a second fastening hole disposed in a main body of the reinforcement component.

2. The prefabricated mounting assembly of claim 1, wherein:
the plurality of ribs comprises a pair of uppermost protruded ribs each spaced apart from an undersurface of the top surface and protruding inwardly from the pair of side parts; and
the reinforcement component is disposed between the top surface of the mounting bracket and the pair of uppermost protruded ribs.

3. The prefabricated mounting assembly of claim 2, wherein the reinforcement component is detachable from the mounting bracket.

4. The prefabricated mounting assembly of claim 2, wherein the reinforcement component is movably inserted into the mounting bracket.

5. The prefabricated mounting assembly of claim 2, wherein a rib of the plurality of ribs separates an internal space of the mounting bracket into upper and lower spaces.

6. The prefabricated mounting assembly of claim 2, wherein the mounting bracket and the reinforcement component are engaged with each other by a second fastener configured to fasten the first fastener.

7. The prefabricated mounting assembly of claim 2, wherein the reinforcement component is inserted into the mounting bracket from a first side of opposite sides of the top surface of the mounting bracket.

8. The prefabricated mounting assembly of claim 7, wherein an anti-disengagement protrusion protruding upwardly and an anti-disengagement step protruding downwardly are respectively disposed on front and rear ends of the reinforcement component in an insertion direction of the reinforcement component.

9. The prefabricated mounting assembly of claim 8, wherein the anti-disengagement protrusion and the anti-disengagement step are configured to be stopped by the pair of uppermost protruded ribs.

10. A prefabricated mounting assembly comprising:
a mounting bracket comprising:
a top surface comprising a first fastening hole;
inwardly recessed stopper notches disposed at opposite sides of the top surface;
a pair of side parts extending downward from opposite ends of the top surface; and
a plurality of ribs disposed between the side parts, the plurality of ribs comprising a pair of uppermost protruded ribs each spaced apart from an undersurface of the top surface and protruding inwardly from the pair of side parts; and
a reinforcement component disposed between the top surface of the mounting bracket and the pair of uppermost protruded ribs, the reinforcement component comprising a first fastener engaged in a second fastening hole disposed in a main body of the reinforcement component.

11. The prefabricated mounting assembly of claim 10, wherein:
the reinforcement component is inserted into the mounting bracket from a first side of the opposite sides; and
an anti-disengagement protrusion is disposed at a front end of the reinforcement component in an insertion direction of the reinforcement component, wherein the anti-disengagement protrusion protrudes upwardly.

12. The prefabricated mounting assembly of claim 11, wherein the anti-disengagement protrusion protrudes upwardly in a curved manner.

13. The prefabricated mounting assembly of claim 12, wherein the curved manner of the anti-disengagement protrusion is set such that the anti-disengagement protrusion is elastically deformed and seated into the stopper notch disposed on the first side of the mounting bracket.

14. The prefabricated mounting assembly of claim 11, wherein the reinforcement component further comprises longitudinal position-restricting protrusions protruding outwardly from opposite side parts relative to the insertion direction.

15. The prefabricated mounting assembly of claim 14, wherein a gap is defined between each of the longitudinal position-restricting protrusions of the reinforcement component inserted into the mounting bracket and an inner surface of the mounting bracket.

16. The prefabricated mounting assembly of claim 11, wherein the reinforcement component comprises vertical position-restricting burring flanges protruding downwardly at front and rear ends of a side portion of the reinforcement component relative to the insertion direction.

17. The prefabricated mounting assembly of claim 16, wherein a gap is defined between the vertical position-restricting burring flanges of the reinforcement component inserted into the mounting bracket and the uppermost protruded ribs.

18. The prefabricated mounting assembly of claim 11, wherein an anti-disengagement step is disposed at a rear end of the reinforcement component relative to the insertion direction, wherein the anti-disengagement step protrudes upwardly and is stopped by the stopper notch disposed on the first side of the mounting bracket.

19. The prefabricated mounting assembly of claim 18, wherein a gap is defined between the anti-disengagement protrusion and the stopper notch disposed on the first side of the mounting bracket and between the anti-disengagement step and the stopper notch disposed on the first side of the mounting bracket.
